(19) United States
(12) Patent Application Publication
(10) Pub. No.: US 2007/0053542 A1
(43) Pub. Date: Mar. 8, 2007

(54) Bone conduction speaker

(76) Inventor: Dong-Won Lee, Seoul (KR)

Correspondence Address: Golden Dance Co., Ltd.;Attn: Mr. Nakatani, 3-22-19, Furuichi, Jotou-Ku, Osaka, 536-0001, JP

(21) Appl. No.: 11/516,861

(22) Filed: Sep. 7, 2006

(30) Foreign Application Priority Data
Sep. 8, 2005 (KR) 20-2005-0025945

(51) Int. Cl. H04R 25/00

(52) U.S. Cl. 381/380

(57) ABSTRACT

A bone conduction speaker is utilized for hearing aid and other devices. The speaker's structure is improved by arranging a single permanent magnet above an iron piece coupled to a vibrating plate fixed to a resonator, containing at least one sound coil, enclosing a magnetic core located substantially beneath the center of plate. Audio signals are converted into oscillating current, input in the coil that alternates attractive/repulsing forces applied to the iron piece producing vibrations of the plate amplified by the resonator, further conducted through skin and skull to auditory nerves for sound recognition. The structure allows avoiding laborious adjustments of the permanent magnet means during the assembly process, freeing the internal space of resonator, enlarging the coil and core, improving performance, making the speaker compact and lightweight, reducing production costs. An embodiment is furnished with upwards standing parts disposed at two resonator's opposite ends, forming stable structure.

### CROSS REFERENCE TO RELATED APPLICATIONS

This application claims priority under 35 U.S.C. 119(a) through (d) from a patent application No. 20-2005-0025945 filed on 8 Sep. 2005 in Korea.

### BACKGROUND OF THE INVENTION

The present invention relates to vibrators preferably utilized in hearing aid devices, assistive listening devices, audio and communication devices of the bone conduction type, wherein audio or other acoustic signals (sounds) are transmitted through the skull bone directly to the cochlea (inner ear) of a person, where the audio signals can be consciously recognized.

The vibrators, or bone conduction speakers, can be combined with hearing aids used by hearing impaired people, with headphones that are used at call centers where the surrounding conversation must be listened, or with the headsets that are used for radio communications and for music listening etc. Such devices make use of an audio signals transmission mechanism distinct from the traditional air conduction (in which air is vibrated to develop sound waves to further transmit to ears). This transmission mechanism is called bone conduction. Bone conduction provides for conversion of sounds to mechanical vibrations via a vibrator, which vibrations are conducted through a directly contacted member (e.g. the skull bone) to auditory organs of a person or, for example, an animal. The vibrations on and through the skull can be perceived by auditory nerves and hence the sounds can be recognized through such a process rather than through the usual vibrations of eardrums.

Such a bone conduction speaker for similar purpose has already been invented in Japan and disclosed in a Japanese Invention Patent No. 2967777, hereby entirely incorporated by reference, and illustrated in FIG. 7 herein. It comprises a central magnetic core (2) and a sound coil (3) wound around the core 2. The core 2 and coil 3 are mounted on a resonator (1) with four extensions. The resonator 1 includes two cavities (4, 4′) positioned at opposite sides of the coil 3, so that the core 2 is substantially located in the center. The speaker comprises two permanent magnets (5, 5′) shaped as a rectangular prism. The magnets 5, 5′ are mounted in the cavities 4, 4′.

By improving this structure one can easily increase the diameter of the central magnetic core 2 and the number of wire turns of the coil 3, leading to a higher sound quality and compact profile. There is an important condition however: the magnets 5, 5′ should exactly face each other, that is, should be positioned essentially symmetrically, since the positions of the magnets 5, 5′ and their orientations appeared to be the key factors affecting the speaker's performance.

However, as suggested in the aforesaid invention description, the exact symmetrical placing of two rectangle prism magnets, facing each other at the two opposite sides of the coil 3 is not an easy job in the manufacturing process. It needs a substantial adjustment and this will slow down the process. On the other hand, this operation increases the production cost as well.

### BRIEF SUMMARY OF THE INVENTION

In order to solve the above mentioned problem, instead of putting the magnets 5, 5′ near the coil 3, only one permanent magnet is mounted on top of an iron piece fixed to a vibrating plate attached to the resonator. It is therefore unnecessary to adjust the position of the magnet, which allows for enlarging the coil's and the magnet's sizes, and consequently it is possible to easily adjust the output power and to make the speaker compact and lightweight.

According to an embodiment of this invention, only one magnet is made as a single part of the speaker. Thus, it is not necessary to adjust its direction and therefore the assembling process is simplified, and the production cost can be largely reduced. Since the permanent magnet is positioned at top of the iron piece, rather than surrounding the coil, the size of the coil can be increased (there is no space needed for placing permanent magnets inside the resonator), as well as the magnet's size, in order to improve the speaker performance depending on the application. Then the speaker can be built compact and lightweight.

An embodiment of the inventive speaker is furnished with upwards standing parts disposed at two opposite ends of the resonator, forming a stable structure. The magnetic flux lines of the permanent magnet extend through a path from the center of the coil to the vertically standing parts, forming magnetic loops and converting the electromagnetic oscillations of the sound coil into mechanical vibrations of a vibrating plate with much higher efficiency.

According to this invention, it is also possible to set a number of sound coils and central magnetic cores in the resonator to further improve control of the sound.

### BRIEF DESCRIPTION OF THE DRAWINGS

FIG. 1 is an exploded view of the bone conduction speaker, according to an embodiment of the present invention.

FIG. 2 is a cross-sectional view of the speaker, according to the embodiment of the present invention shown on FIG. 1.

FIG. 3 is a cross-sectional view of the bone conduction speaker with a housing, according to another embodiment of the present invention.

FIG. 4 is a cross-sectional view of the bone conduction speaker with vertically standing parts, according to another embodiment of the present invention.

FIG. 5 is an upper plan view of the bone conduction speaker with two sound coils, according to another embodiment of the present invention.

FIG. 6 is an upper plan view of the bone conduction speaker with three sound coils, according to another embodiment of the present invention.

FIG. 7 is an upper plan view of the bone conduction speaker, according to Japanese Invention Patent No. 2967777.

### DESCRIPTION OF PREFERRED EMBODIMENTS OF THE INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

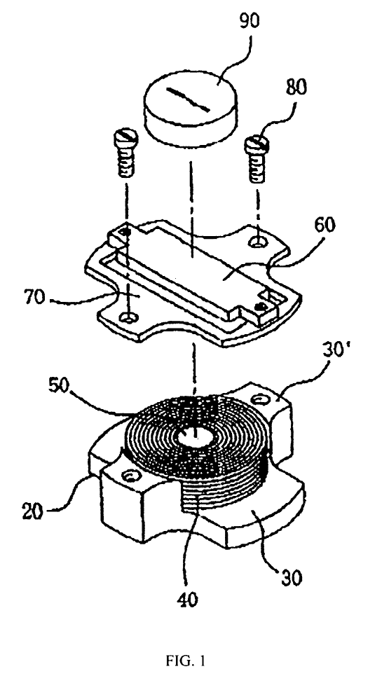

As illustrated on FIG. 1, an embodiment of the inventive speaker comprises resonator means, including a plate-shaped resonator (20) mounted in a housing (not shown in FIG. 1). The resonator 20 includes two radially extended parts 30 and two upward standing radially extended parts 30′. Each extended part 30 and 30′ has a horizontal axis preferably positioned at a right angle to the neighboring extended part's horizontal axis.

The embodiment of the inventive speaker, shown on FIG. 1, comprises electromagnetic oscillation means including a sound coil (40) and a central magnetic core (50) substantially centrally mounted within the coil 40. The coil 40 with the core 50 therein are disposed in the resonator 20.

The embodiment depicted on FIG. 1 comprises vibration means to produce mechanical vibrations, including a vibrating plate (70), attached to the parts 30′ by screws (80), and a piece of iron (60) coupled to the plate 70.

As illustrated on FIG. 1, the embodiment of the inventive speaker comprises permanent magnetic means, including a permanent magnet (90), attached to the upper central part of the iron piece 60.

More specifically, the aforesaid central magnetic core 50 is disposed substantially vertically and centrally inside the coil 40, placed within the resonator 20. The parts 30, 30′ of the resonator are extended along the four radial directions, wherein each direction is perpendicular to the two adjacent directions. The two parts 30′ facing each other are appropriately higher than the sound coil 40, and central magnetic core 50. There is a screw hole drilled from the upper surface of each part 30′.

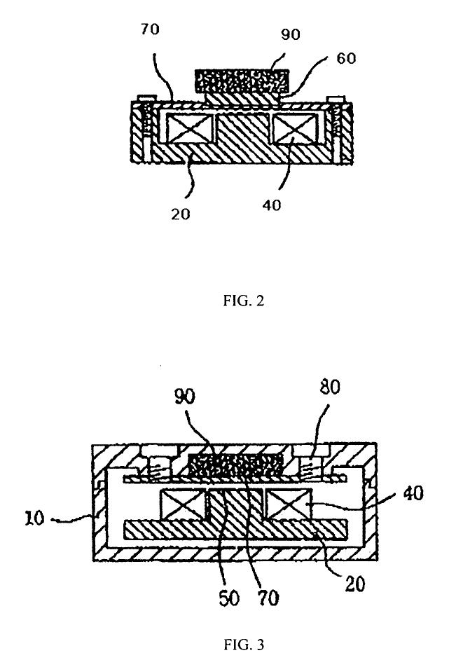

The vibrating plate 70 has approximately the same cross shape as the resonator 20 with four directionally extended parts corresponding to the parts 30, 30′. Two screw holes are drilled at the positions corresponding to those on the parts 30′ allowing for connection with the screws 80. Therefore, the vibrating plate 70 can be fixed onto the two parts 30′ of the resonator 20 by screws 80. In the assembled state of the speaker, there is a small clearance between the vibrating plate 70 and the sound coil 40, and between the vibrating plate 70 and the central magnetic core 50 respectively, as shown on in FIGS. 2 and 3.

On the upper surface of the vibrating plate 70 a rectangular trench is cut where the iron piece 60 is mounted, as shown on FIG. 1. The iron piece 60 approximately follows the shape of a strip formed by the two oppositely extended parts 30 from one side of the resonator 20 to the other. The core 50 is disposed substantially underneath the center of the iron piece 60. The two ends of the iron piece 60 are fixed to the plate 70. The permanent magnet 90 locates at the center of the iron piece 60, i.e. above the central core 50.

The permanent magnetic flux lines extend from the permanent magnet 90 through the iron piece 60, central magnetic core 50, resonator 20, the extended parts 30, 30′, and then return to the permanent magnet 90, forming magnetic loops. The iron piece 60 is therefore attracted to the core 50 by magnetic forces of the permanent magnet 90.

When a voice signal converted into an electric current is input into the sound coil 40, additional oscillating magnetic forces will appear above the core 50, and the pulling forces between the iron piece 60 and the central magnetic core 50 will vary, resulting in mechanical vibrations of the vibrating plate 70.

Another embodiment of the invented bone conduction speaker comprising a casing (10) is depicted on FIG. 3. The resonator 20 and sound coil 40 are located inside of the casing 10, shaped as an up-end opened box, and the vibrating plate 70 is fixed to a cover, covering the casing 10, by the screws 80. As a result, there is a little clearance between the vibrating plate 70 and the sound coil 40, and between the vibrating plate 70 and the core 50, as shown in FIG. 3. The permanent magnet 90 is mounted at the center of the upper surface of the vibrating plate 70, i.e. above the position where the central magnetic core 50 is situated. In FIG. 3 the iron piece 60 is not shown.

FIG. 4 illustrates another embodiment of the inventive speaker, comprising two upward vertically standing parts 100 formed at opposite ends of the resonator 20, which standing parts can create more stability.

In the examples shown in FIG. 1 and FIG. 2, the vertically standing parts 100 can also be formed at the extended parts 30 (without screw holes) on the resonator 20. In such an embodiment (not shown), the permanent magnetic flux lines extend from the permanent magnet 90 through iron piece 60, central magnetic core 50, resonator 20, and its extensions 30, 30′ to the vertically standing parts 100, and then back to the permanent magnet 90, forming magnetic loops, which provides more stability, and consequently the sound vibrations produced by the vibrating plate 70 will be more stable as well. The permanent magnet 90 in the above mentioned examples could be performed in different shapes, for instance, as a cylinder or a rectangular prism, etc.

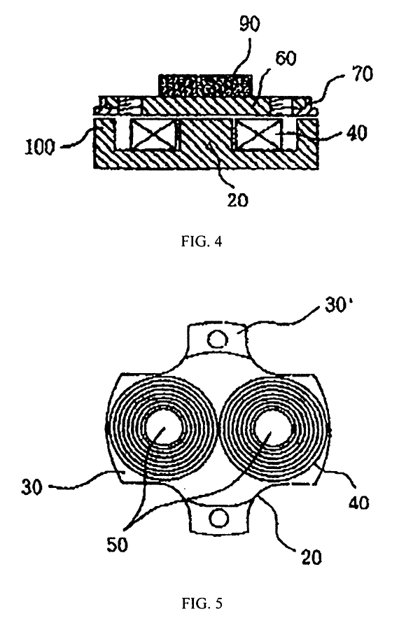

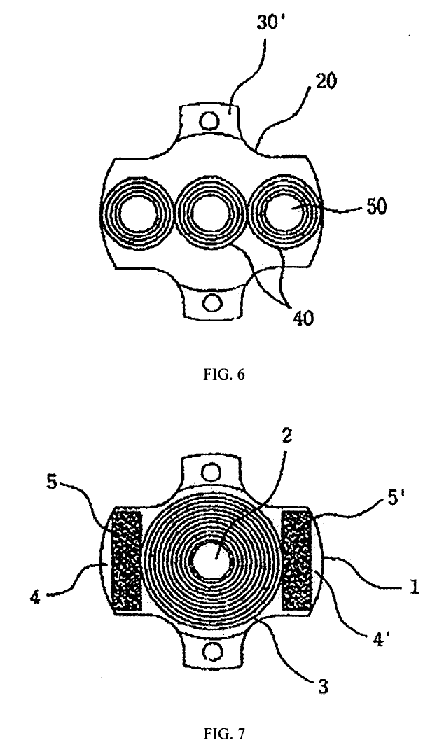

In other embodiments of the invention, shown in FIGS. 5 and 6, a plurality of sound coils 40 (for example 2 or 3), each having a central magnetic core 50, can be mounted on the resonator 20.

The current of audio signals in the sound coil 40 creates an oscillating electromagnetic flux inside the coil and in the core 50. The oscillating flux results in interactions, due to the alterations of pulling and repelling forces, between the magnetic core 50 and the vibrating plate 70, and, on the other hand, between the permanent magnet 90 and the vibrating plate 70. These interactions lead to vibrations of the vibrating plate 70, further amplified by the resonator 20. The vibrations can be conducted through the skin to the skull, further stimulating human auditory nerves, and hence the sound signals are perceived and recognized by the person using the bone conduction speaker.

Since the permanent magnet 90 is situated on the top of the vibrating plate 70, the magnet's orientation in the process of assembling and the magnet's shape does not essentially affect performance of the speaker, which allows making the assembling process easier. Meanwhile, this can also easily increase the effective space inside the resonator structure, making it possible to freely increase the sizes both of the sound coil and the core according to actual performance requirements. The speaker performance can be tuned, for example, by arrangement of movement of the permanent magnet 90 closer to or further from the iron piece 60 (not shown in the drawings). Similarly, the clearance between the vibrating plate 70 and the sound coil 40, and between the vibrating plate 70 and the core 50 can be fine-tuned to optimize the performance of the speaker.

### CONCLUSIONS

According to the exemplified above embodiments (and similar embodiments that may be designed and built by an ordinary person skilled in the art based on the present disclosure) of the inventive bone conduction speaker, only one permanent magnet is necessary to provide the required functionality of the device. Its center should be located substantially above the center of the magnetic core and the sound coil. This allows avoiding laborious adjustments of its position by spending lots of time of assembling workers. It therefore makes the assembly process much easier and the production cost can be expected to reduce greatly.

Furthermore, since the magnet is located on top of the iron piece, rather than around the sound coil, it enlarges the effective space inside the resonator structure, therefore, making it possible to freely increase the sizes both of the sound coil and the core, and so the speaker can be built compact and lightweight and its performances can be easily adjusted.

It will be understood that each of the elements described above, or two or more together, may also find a useful application in other types of constructions and methods differing from the types described above. While the invention has been illustrated and described as utilized in hearing aid, headphones, radio headsets, and music listening, and other audio related devices, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A bone conduction speaker comprising
a) electromagnetic oscillation means for creation of an oscillating magnetic flux predetermined by signals input into the electromagnetic oscillation means;
b) permanent magnetic means for creation of a permanent magnetic flux, said permanent magnetic means configured to cooperate with said electromagnetic oscillation means;
c) vibration means for interaction with said electromagnetic oscillation means and said permanent magnetic means to produce mechanical vibrations predetermined by said oscillating magnetic flux; and
d) resonator means configured to amplify the mechanical vibrations of said vibration means.

2. The bone conduction speaker according to claim 1, further comprising casing means for housing said electromagnetic oscillation means, permanent magnetic means, vibration means, and resonator means.

3. The bone conduction speaker according to claim 1, wherein
said permanent magnetic means performed in the form of a single permanent magnet;
said electromagnetic oscillation means comprising at least one sound coil and at least one central magnetic core substantially centrally mounted within the coil;
said at least one coil with said at least one core disposed in the resonator means;
said vibration means comprising a vibrating plate, attached to the resonator means, and a piece of iron, coupled to the vibrating plate; and
said permanent magnet installed above the iron piece.

4. The bone conduction speaker according to claim 1, wherein
said resonator means comprising a plate-shaped resonator including at least two upward vertically standing parts formed at opposite ends of the resonator.
